(19) United States
(12) Patent Application Publication
(10) Pub. No.: US 2021/0012256 A1
(43) Pub. Date: Jan. 14, 2021

(54) STRUCTURED LIABILITY RISKS PARAMETRIZING AND FORECASTING SYSTEM PROVIDING COMPOSITE MEASURES BASED ON A REDUCED-TO-THE-MAX OPTIMIZATION APPROACH AND QUANTITATIVE YIELD PATTERN LINKAGE AND CORRESPONDING METHOD

(71) Applicant: Swiss Reinsurance Company Ltd., Zurich (CH)

(72) Inventors: Nikita KUKSIN, Zurich (CH); Raphael Troitzisch, Zurich (CH)

(73) Assignee: Swiss Reinsurance Company Ltd., Zurich (CH)

(21) Appl. No.: 17/037,130

(22) Filed: Sep. 29, 2020

Related U.S. Application Data
(63) Continuation of application No. PCT/EP2019/057238, filed on Mar. 22, 2019.

(51) Int. Cl. G06Q 10/06; B60W 40/09; G06F 17/18

(52) U.S. Cl. CPC G06Q 10/0635; G06F 17/18; B60W 40/09

(57) ABSTRACT

A system and method for providing a liability temperature measure based on a time-dependent, composite indexing parameter. Measurement parameters assigned to parameterized liability risk drivers are measured for generating the measured time-dependent, composite indexing parameter. The used liability risk drivers are selected based on their impact to the measured variable composite index parameter and dynamically normalized to each other. The normalization is based on a defined transformation applied to the final time series of the parameters providing individual set weights. Based on the weighted liability risk drivers and sets of liability risk drivers, a minimum number of liability risk drivers in relation to maximized statistical significance is selected by applying an index assembly and validation unit. The index assembly and validation unit provides the minimum number of liability risk drivers as a reduced set of liability risk drivers out of all available liability risk drivers using best fit characteristics.

### CROSS-REFERENCE TO RELATED APPLICATIONS

This is a continuation application of International Patent Application No. PCT/EP2019/057238, filed on Mar. 22, 2019, the disclosure of which is hereby incorporated by reference in its entirety.

### FIELD OF THE INVENTION

The present invention relates to automated systems and methods for automated triggering, tracking, parametrizing, modeling and forecasting developments of liability loss measures. In particular, it relates to automated forecast systems providing alternative measures to a-priori loss ratio measures (APLR) derived from costing analysis conducted by human experts. It also relates to automated, electronic steering and signalling systems interacting on a portfolio level allowing automated identifying and triggering of key drivers of portfolio loss measures (e.g. economic measures) and automated verification and comparison to predefined risk parameters, e.g. defining company risk appetite such as reduction of risk exposure variables to inflation. Finally, it relates to dynamically triggered, steered or operationally adapted risk-transfer systems, more specifically to the field of risk-transfer systems for liability risk driven exposures of risk-exposed objects. Moreover, this invention relates to automated systems and methods for measuring and forecasting parameters used in designing, signaling and pricing risk-transfer products or risk-transfer operating parameters, especially by measuring and forecasting composite measures or index parameters.

### BACKGROUND OF THE INVENTION

Prior art systems for liability index measuring or assessment relied on experience from past accident years losses to predict or forecast development of losses from a current accident year's measures, i.e. to provide an appropriate, reliable index measure. Those systems and methods are associated with great uncertainties, especially for liability measures due to the influence of economic, legal and societal trends and the different ways, in which they impact liability loss measures and factors. There is a big need to provide an automated system which is able to take these factors into account more directly, allowing for faster, more efficient and more accurate forecasting of their impacts. In particular, there is a need for liability prediction systems providing a reliable and accurate measure to be able to (i) track past developments of liability loss parameters, (ii) provide alternative and more precise estimates and forecasts of loss measures in more recent years, (iii) automatically identify key contributing parameters to liability loss parameters, define their interaction and verify the generated, statistical-based hypothesis, (iv) allow for automation of manual actuary work typically conducted by human experts by providing an alternative measuring, prediction and estimation system providing liability loss measures (i.e. indexes) for most recent accident years for reserving processes in addition to a-priori loss ratio measures (APLR) derived from costing analysis, (v) reserve review process by providing additional, independent measures of reserve adequacy given observed changes in external factors, (vi) provide automated steering and signalling on a portfolio level by allowing automated identification and triggering of key drivers of portfolio loss measures (e.g. economic measures) and automated verification and comparison to predefined risk parameters, e.g. defining company risk appetite such as reduction of risk exposure variables to inflation, and (vii) provide automated signalling and steering for planning and monitoring systems by identifying key driver parameters of a portfolio and by using the generated forecast values for automated estimation of future portfolio developments.

Liability-dependently operated systems are complex. This is even more true for liability systems acting on measures of complex constellations such as the US liability regime. However, the operation of any liability-dependently operated systems belongs to the most complex objects of automation engineering. The operation of such liability systems heavily depends on measured or otherwise available data on detention capacity and storage, such as automated adjusted risk-transfer premiums, measured ranges of losses and related outgoings of the detention, such as expenses. Operating instabilities of the liability-dependent operated systems may be caused by mutual-dependencies among liability-dependent risk-transfer systems, e.g. introduced by collusion among such systems, cyclic behaviour in their operation, or systematic errors in the device-driven forecasting of measures for losses. However, most often, measuring evidences indicates that a sudden increase in liability risk transfer premiums during operation of the systems is due to an over-optimization of the operability of the systems due to the exceeding and uncontrolled increase in growth in the discounted value parameters providing a measure for the expected or automatically predicted liability loss magnitude. Therefore, to allow a stable automation of such liability-dependently operated systems, there is a great demand for a better automated decoding of the current operating temperature of the liability systems, which may technically be measured or depicted for example in the measuring parameters of a composite index.

How difficult the operation of the liability-dependently operated systems is and how big the demand of a stable automation of the forecast of appropriate measuring parameters and stable operability of the liability-dependent risk-transfer systems are, becomes evident by its historical background. As it became public in the 1980s as so-called insurance crises, it is regarded as having a similar impact as the energy crises of the 1970s, where in 1984 and 1985 industry was confronted by almost daily reported examples of fast escalating retention demands or premiums of liability risk-transfer systems, while the operator of these systems reported large and increasing operating losses.

Risk exposures and liabilities arising out of occurring risk events may dangerously affect all kinds of industries in a great variety of aspects, each affecting exposure and having its own specific characteristics and complex behavior. The complexity of the behavior of risk exposure-driven technical processes often has its background in the interaction with chaotic processes occurring in natural or artificial environments. Good examples of the associated technical problems can be found in weather forecasting, earthquake and hurricane forecasting or controlling of biological processes such as related to heart diseases or the like. Monitoring, controlling and steering technical devices or processes interacting with such risk exposure is one of the main challenges of engineering in industry in the 21st century. Dependent or educed systems or processes from products exposed to risks such as automated pricing tools in insurance technology or forecast systems for natural perils or stock markets, etc. are naturally connected to the same technical problems. Pricing insurance products is additionally difficult because the pricing must be done before the product is sold but must reflect results that will not be known for some time after the product has been bought and paid for. With tangible products, “the cost of goods sold” is known before the product is sold because the product is developed from raw materials which were acquired before the product was developed. With insurance products, this is not the case. The price of the coverage is set and all those who buy the coverage pay the premium dollars. Subsequently, claims are paid to the unfortunate few who experience a loss. If the number of claims paid is greater than the amount of premium dollars collected, then the insurance system will make less than their expected profit and may possibly lose money. If the insurance system could predict the number of claims to be paid and has collected the right amount of premiums, then the system will be profitable.

Optimized pricing of risk transfer is triggered by the typically continuously altering and shifting exposure of an object to a specific risk or peril and normally by a set of assumptions related to expected losses, expenses, investments, etc. Generally, the largest amount of money paid out by an insurance system is in the payment of claims for loss. Since the actual amounts will not be known until the future, the insurance system must rely on assumptions about what the losses for which exposure will be. If the actual claims payments are less than or equal to the predicted claims payments, then the product will be profitable. If the actual claims are greater than the predicted claims in the assumptions set in pricing, then the product will not be profitable, and the insurance system will lose money. Hence, the ability to set assumptions for the expected losses is critical to the operational stability of an automated risk-transfer system and hence for the success of the system. The present invention was developed to optimize triggering of liability risk-driven exposures in the risk-transfer and automated insurance system technology and to give the technical basics to provide a fully automated pricing signaling for liability exposure comprising self-adapting and self-optimizing means based upon varying liability risk drivers.

Fine-tuning and operational optimization is a fundamental technical issue in modern risk-transfer technology. Liabilities for losses typically account for up to 80 percent of a traditional risk-transfer system's resource demand, making the technical structure by which risk is balanced by the resources and how claims are processed vital and critical to the risk-transfer system's operational stability and survival. This is particularly true for times of economic pressure, with growing necessity to cover losses and settle claims faster with more transparent operational structures, but with as few resources as possible. Unfortunately, automated risk-transfer systems are complex, so that operational optimization, loss-ratio balancing and claims processing is typically time-consuming and labor-intensive, involving multiple systems, outdated technology and distributed operational units. Difficulties in automated balancing of unexpected losses are an additional shortcoming of traditional risk transfer systems. Because traditional risk management and risk transfer systems are necessarily driven by statistical assessment or by prior history measuring methods, they are generally limited to dealing with measured or otherwise captured events that vary within ranges of parameter values that have already been captured and experienced. One of the problems with this is that large losses are often caused by events that fall outside the bounds of normal experience, i.e., hundred-year floods and once-in-a-lifetime events, or casualty events such as asbestos or lead poisoning. However, smaller variations may also be corruptive to the operation of automated risk transfer and/or management systems, since the pooled resources covering transferred risks typically need to be optimized. For example, if the likelihood of the occurrence of a risk event is so high, or the costs of the event so large, or the pooled resources are not properly minimized related to the transferred risks, the resulting resources to be pooled are large relative to the amount of protection achieved, i.e., risk transferred. It is then not likely that a risk-exposed element will transfer its risk to the corresponding risk-transfer system.

For risk-transfer systems, the so-called loss ratio provides a measure for the operational stability of the system. The loss ratio is the ratio of total losses incurred, paid, and reserved in claims plus adjustment expenses due to maintaining the system, divided by the total pooled resources, e.g., premiums as denominator. Loss ratios for property and casualty insurance systems, e.g., motor car insurance, can for example range from 40% to 60%. Such systems are collecting more premiums than the amount of resources transferred to cover losses. In contrast, risk-transfer systems that consistently experience high loss ratios will not be able to maintain long-term operation. In the prior art, sometimes the terms “permissible”, “target”, “balance point”, or “expected” loss ratio are used interchangeably to refer to the loss ratio necessary to fulfill the system's operational goal to maintain its operation. However, in this application, the expected loss is only what it is. The loss that is expect or forecasted by the system. Thus, it has nothing to do with the “maximum losses to enable continued operation”.

Automated risk transfer systems and appropriate techniques are vastly employed and implemented in many prior art risk transfer systems and insurance technology systems. Thus, in the last decade, apart from the traditional channels of financing risks, alternative routes based on automated, self-sufficient risk transfer systems and/or insurance systems have been developed. Self-sufficiency or self-containment in the context of this document is directed to systems capable of automated, long-term operation without operational interruption due to unbalanced resources. Thus, self-sufficiency defines an operating state not requiring any aid, support, or interaction, for keeping up the operation, i.e., the system is able to provide for survival of its operation independent of any human interaction. Therefore, it is a type of operational autonomy of an automated system. On an operational automation scale, a system with totally self-sufficient operation does not need manual external adjustments for its operation to initiate or uphold its operation, i.e., it is able to work in operational autonomy. The present invention also allows extending this technology to an optimized multi-tier risk transfer structure with mutually and dynamically tuned triggers by interaction with externally measured or otherwise externally captured environmental parameters, thereby reinforcing the importance of developing automated systems allowing a self-sufficient operation. Tuned means that the trigger parameters of the two trigger layers are dynamically adapted and transferred between the triggers. As described, the layered trigger structure tied to externally occurring conditions and events allows for a new form of maintaining and ensuring long-term operation of automated, autonomous operable risk-transfer systems, and further optimizing the operation and pooled resources of the systems.

The automation of modern insurance systems has been largely concentrated on the problem of how risk-averse or risk-sensitive components can beneficially and automatically transfer their risks to automated risk-transfer and risk-management systems. Since the underlying problem has a statistical nature, the likelihood of a risk transfer system being triggered by a risk event comes close to certainty over an appropriately long time horizon, and the operation of the system thus cannot be steered by the condition of measuring the occurrence of a risk event, but rather when such a risk event is measured. An optimized operation of a risk transfer depends on its structure and tuning based on the ability to forecast future risk event measurements. The level of uncertainty is high, since it affects the risk transfer structure and operation of the system. To relieve this problem, one of the characteristics of risk transfer systems is the pooling of risks and risk transfers. In the prior art, the pooling of risk transfers can typically involve the grouping, selecting and filtering of various risk exposures to provide a more accurate prediction of future losses. From a technical point of view, if the losses associated with risk transfer are more predictable, the operation and management of the actual risk transfers can be optimized. Additional risk transfer is another important element, where first risk transfer or insurance systems can optimize or stabilize operation by partially shifting pooled risks to a third system, as a second insurance system. In the prior art, automated risk transfer systems have been used for quite some time as a technical tool to manage the risk of uncertain losses, in particular to keep up the operation of functional, technical or business units. However, despite the vast developing technology since 1995, the loss-ratios of many of the systems shows loss ratio peaks >120%, which is critical to the operational stability of the risk-transfer systems. FIG. 3 shows the flow of the general liability loss ratio on an accident year basis of the US system. The reason is, that the US liability system, like other systems, is complex and technically difficult to capture. Decoding it by understanding its current temperature and predicting its future flow, would make it possible to provide a time-dependent, composite index parameter that would be a measure for the flow of the risk-exposure and the correlated liability. Such a dynamically measured index parameter is, however, technically fundamental for the automation of the risk-transfer systems.

In summary, in the prior art, existing systems, whose operations are at least partially based on risk transfer schemes or structures, come in many different forms, often with very different objectives and operational approaches. However, typically, the range of schemes or structures of the prior art systems is specific to one particular risk, risk category, locality, sector or country. Moreover, there is no system capable of providing a precise, dynamic measurement and prediction based on changes in losses over multiple years. Furthermore, these systems do not provide a self-sustaining interaction with the environment, and do not provide means for self-adjustment of their operation, thus do not allow for a stable long-term operation of systems. In this context, it is important to note that the limitations of the prior art risk-transfer systems previously discussed are also driven by the lack of information, this problem also extending to the risk analysis, so that they must rely completely on the information provided to them. These same limitations also extend to all known efforts to analyze and/or simulate the impact of changes in the transferred risks. However, it is impossible to forecast the impact on risks with no prior information. The lack of information also limits simulation and/or dynamic analysis systems, to protect against the impact of changes in the pooled risks. Similarly, the lack of quantitative information on the impact of risks has limited the usefulness of automated risk-transfer systems. Concerning the optimization of automated resource pooling and pricing of a specific risk-transfer, the prior art systems typically start with the basic loss tables. Then, based upon judgments concerning the specific nature of the table, the risk to which it is applied, the design of the product, the risk selection techniques applied at the time the policy is issued, and other factors, the risk-transfer system for example can comprise a set of assumptions for the cumulative loss rates to serve as the foundation for the expected future claims of the product and its risk exposures, respectively. Depending upon the specific insurance product being developed, the historical data and data from the loss tables do not always correlate well with the specific risks that the policy must cover. For example, most historical data and/or insurance tables deal with the average probability of loss in an insured set of insured objects. However, some insurance products are directed to subgroups in a set. For example, exposure may drastically vary in these subgroups. For example, insured objects in an urban environment may not show the same liability exposure as such objects in a rural environment, i.e. may be region-dependent. In order to price risk-transfer for such objects, risk-transfer systems must be able to segment the cumulative loss rate from the standard loss tables into cohorts to tease out the loss of those who are objectively less risk-exposed within the standard group, and to tune assumptions on these more specific subsets of the population. Segmenting these cumulative loss rates requires that the insurance system must somehow be able to trigger risk factors for loss which characterize the general insured set of insured objects versus the risk factors which signal the subset with preferred loss. However, most historic data and/or standard loss tables do not take into consideration such separate risk factors. The risk-transfer systems should be able to trigger other sources of data to determine loss rates of specific subsets of insurance objects and/or conditions and the risk factors which are correlated with them. Then, in the process of pricing a risk-transfer which differentiates price based upon the risk factors, the risk-transfer system must set assumptions as to how these risk factors correlate with the cumulative loss rates in the loss table. Therefore, designing and pricing a specific risk-transfer is often an adaptive process which is difficult to achieve by technical means. To arrive at the overall exposure, the risk-transfer system must be able to trigger the appropriate assumptions of loss in which there may be multiple risk factors and drivers, each one, individually or in combination with other factors, derived from different simulations, historical data and loss tables. Thus, prior art systems are typically not able to technically handle such complex occurring patterns of risk drivers and correlation.

An example of a prior art system is disclosed by EP 2461286 A1. EP 2461286 A1 show a system for forecasting frequencies associated to future loss and loss distributions for individual risks by independently operated liability risk drivers. In case of an occurring loss at a loss unit, measure parameters are measured and transmitted to the control unit controller and dynamically assigned to the liability risk drivers. Measuring devices assigned to the loss units are dynamically scan for measure parameters and measurable measure parameters capturing a characteristic of a liability risk driver are selected. A set of liability risk drivers is selected by a driver selector of the control unit controller parameterizing the liability exposure of an operating unit, and a liability exposure signal of the operating unit is generated based upon the measured and selected measure parameters. The driver selector adapts dynamically the set of liability risk drivers varying the liability risk drivers in relation to the measured liability exposure signal by periodic time response, adjusting the measured liability exposure signal. WO 2016206718 A1 shows a further system of the state of the art. A layered risk-transfer system comprising an independent operated clash loss event triggering risk transfer system. The risk transfer structure of the system captures risk transfers of the exposure to multiple retentions of the components that may occur when two or more of the associated risk exposure components suffer a loss from the occurrence of the same risk event. An automated switching captures the covers of the additional retentions. The risk transfer structure of the system triggers and dynamically handles clash loss events simultaneously impacting various layers and/or segments of the risk transfer structure. In particular, it provides a dynamically altered switching between the different layers of the risk transfer structure. WO 200249260 A2 show a prior art system, which accurately and consistently predict risk-transfer profitability based on a generated statistical model. The system allows to incorporate non-insurance related data from external data sources on a prospective basis regardless of the internal operational data of a particular risk-transfer system and performed risk-transfers. The system associates the external captured variables with the risk-transfer parameters, evaluating the associated external variables against the risk-transfer parameters to identify the individual external variables predictive of the risk-transfer's profitability, and creating a statistical model based on the individual external predictive variables. Finally, the document “Incorporating Economic Forecasts into CECL (Current Expected Credit Losses)”by Sohini Chowdhury, Moody's Analytics, Jul. 19, 2018 shows a method for generating and analyzing economic forecasts for expected credit losses mainly forecasting parameters related to consumer loans. The method uses different possible scenarios related to assumed risk drivers. Based on the different possible scenarios influencing the behavior of the different risk-drivers, the method uses and compares the outcome for the expected credit losses (i) by a qualitative overlay approach of the forecasted values under the different scenarios based on different local condition parameters, (ii) a quantitative overlay approach using preferred scenarios as basis of the forecast, (iii) a multiple scenarios approach using an probability weighted average, and (iv) a simulated scenarios approach based on the generation of a multitude of simulated and varied scenarios.

### SUMMARY OF THE INVENTION

It is an object of the invention to provide an improved, more accurate and more efficient automated decoding and measuring of a parameter or index giving the current temperature of liability-dependent economic measuring factors of regionally defined systems by technically measuring appropriate measuring parameters extracted in a composite index as measure of said temperature. It is a further object of the invention to provide the technical means ensuring a stable and reliable operation of any liability-dependently operated systems, in particular automated liability-dependent risk-transfer systems, which operations and technical requirements are strongly related to the nature and size of fluctuations of liability and liability-dependent measures. Finally, it is an object of the invention to provide the technical means and system for stable automation and signalling of forecasting of appropriate measuring parameters providing a predictive/forecasted measure for possibly approaching alternations or deviations of liability loss ratios or other liability dependent measures. The inventive system should be able to consider liability measures at a defined regional or national level and automatically identifying driving factors that either contract or expand liability indexes and temperature, and that can be validated with capturable measuring data. The invention should also allow for a dynamic liability risk-driven signaling, in particular an appropriate gate signaling, based on a liability risk measure by means of time-dependent, composite indexing of an index parameter and for automated steering and optimization of liability risk-driven interaction between automated devices. The system should be able to automatically and efficiently capture and forecast future liability measure peaks, typically undetected by the prior art systems. In particular, the systems should provide automated optimization and adaption in signal generation by correctly triggering liability risk exposure factors of risk-exposed objects. More particularly, it is an object of the present invention to provide a system which has an improved capability to capture the external and/or internal factors that affect liability exposure, while keeping the used trigger techniques transparent. The system should be able to capture complex, interdependent occurring patterns of said factors, and capture, possible correlations at the same time. Moreover, the system should be better able to capture how and where risk is transferred, which will create a more efficient and correct use of risk and loss drivers in liability risk-transfer technology. Furthermore, it is an object of the invention to provide an adaptive, automated pricing tool for risk-transfer systems based upon the measured liability exposure and index, especially for example for mid-size risks. However, the system is not limited to any size risks, but can be applied to any size of risks. It is an object of the invention to develop automatable, alternative approaches for the recognition and evaluation of liability exposure for facultative risks. These approaches differ from traditional ones in that they necessarily rely on human experts to forecast and hypothesize the most important characteristics and key factors from the operating environment that impact liability exposure. Finally, it is an object to provide a system that is self-adapting and refining over time by utilizing and relying on data as granular statistical measuring data available.

According to the present invention, these objects are in particular achieved with the features of the independent claims. In addition, further advantageous embodiments can be derived from the dependent claims and the related descriptions.

According to the present invention, the above-mentioned objects for a measuring and indexing system measuring and dynamically parametrizing 760 a liability temperature for liability systems, such as the US liability system, by providing an accurate liability risk measure based on a time-dependent, composite indexing parameter, are in particular achieved in that, by means of the present invention, the technology is extended to a dynamic measuring and indexing system measuring measure parameters assigned to parameterized liability risk drivers and transmitting these measuring parameters to a central processing device of the measuring and indexing system for generating the measured time-dependent, composite indexing parameter, in that a liability system is scanned for measure parameters capturing dynamic and/or static characteristics of at least one liability risk driver, wherein impacting liability risk drivers are automatically identified and marked by means of the liability risk-driven system, and wherein the selected liability risk driver either contracts or expands the measured liability risk exposure, in that a first set of liability risk drivers is selected by means a driver selector of the liability risk-driven system parametrizing an economic-based contribution to a general liability exposure loss, wherein the first set of liability risk drivers at least comprises a risk driver parametrizing Gross Domestic Product (GDP) growth, a risk driver parametrizing healthcare expenditure growth, and risk driver parametrizing real wage growth based on the impact of captured alterations to the variable composite index parameter, and wherein the liability risk drivers are mutually normalized to each other, in that additional liability risk drivers are selected by means of the driver selector parametrizing at least societal and/or legal and/or political based contributions to said general liability exposure loss, wherein the system dynamically applies additional liability risk drivers based on their impact to the measured variable composite index parameter and dynamically normalizes the liability risk drivers to each other (e.g. pairwise), in that for normalizing of the selected liability risk drivers a defined transformation is applied to the final time series of the parameters by means of the driver selector providing individual set weights and/or individual driver weights, wherein based on the weighted liability risk drivers and sets of liability risk drivers, a minimum number of liability risk drivers in relation to maximized statistical significance is selected by applying an index assembly and validation unit, and wherein the index assembly and validation unit provides the minimum number of liability risk drivers as a reduced set of liability risk drivers out of all available liability risk drivers using best fit characteristics, and in that the driver selector dynamically adapts the minimum number of liability risk drivers varying the liability risk drivers in relation to the measured liability exposure signal by periodic time response, wherein the time-dependent composite index parameter is generated based on the adapted reduced set of liability risk drivers by means of the liability risk-driven system, and wherein the liability risk-driven interaction between the risk-transfer system and the operating unit is adjusted based upon the time-dependent composite index parameter. The liability system can be defined regionally or nationally measuring any liability dynamics of competitive systems or markets, such as the US liability system. The driver selector can for example dynamically adapt the set of liability risk drivers varying the liability risk drivers in relation to the measured liability exposure signal by periodic time response, wherein the liability risk-driven system comprises an interface module to transmit a request periodically for a measurement parameter update to the measuring devices for dynamic detection of variations of the measurement parameters. The invention has inter alia the advantage that the discussed weaknesses and short-comings of the traditional systems are overcome, which typically apply average trend and development factors to aggregate losses by accident year or policy year. This also applies to systems that are based on line of business specific trend and development factors to individual losses, which are for example not able to handle shock losses.

As an embodiment variant, the impacts of the different liability risk drivers can be scaled to the same scale by applying as normalization the transformation to a final time series x_{†}=[x_{†}-min_{t′}(x_{t′})]/[max_{t′}(x_{t′})−min_{t′}(x_{t′})]. This embodiment variant has inter alia the advantage that the measure parameters and/or liability risk drivers can automatically be weighted. This embodiment variant allows a further self-adaption of the system. However, one of the main advantages lies in the technical purpose of making sure that liability risk drivers can be meaningfully and technical-based compared to one another.

As a further embodiment variant, historic exposure and loss data assigned to a geographic region can for example be selected from a dedicated data storage comprising region-specific data, and historic measurement parameters are generated corresponding to the selected measure parameters and whereas the generated liability exposure signal is weighted by means of the historic measure parameters. This embodiment variant has inter alia the advantage that the measurement parameters and/or liability risk drivers can automatically be weighted in relation to an understood sample of measurement data. This embodiment variant allows a further self-adaption of the system.

In one embodiment variant, measurement parameters of at least one of the liability risk drivers of the set are generated based on saved historic data of a data storage, if the measure parameter is not scannable for the operating unit by means of the control unit controller. This embodiment variant has inter alia the advantage that measurement parameters which are not scannable or measurable can be incorporated in and considered by the automated optimization. As a variant, the system can comprise a switching module comparing the exposure based upon the liability risk drivers to the effective occurring or measured exposure by switching automatically to liability risk drivers based on saved historic data to minimize a possibly measured deviation of the exposures by dynamically adapting the liability risk drivers based on saved historic data.

In another embodiment variant, the measuring devices comprise a trigger module triggering variation of the measurement parameters and transmitting detected variations of one or more measurement parameters to the control unit controller. As a variant, the control unit controller can for example periodically transmit a request for a measurement parameter update to the measuring devices to dynamically detect variations of the measurement parameters.

In another embodiment variant, the measuring and indexing system provides electronic signal generation based on the measured index value steering the liability risk-driven interaction between automated risk-transfer systems or insurance systems and operating units, whose operation can for example be adjusted based upon the adapted liability exposure signal, wherein the automated risk-transfer system is activated by the measuring and indexing system and if the risk-transfer system is activated by the measuring and indexing system, an automated repair node assigned to the risk-transfer system is controlled by means of appropriate signal generation and transmission to resolve the loss of the loss unit. The invention has inter alia the advantage that the control system realized as a dynamic adaptable risk-transfer system can be fully automatically optimized without any other technical or human intervention. In this way, the measuring and indexing system automatically optimizes and adapts signaling generation by triggering risk exposure of insurance objects. In particular, the invention has the advantage of being able to capture in a better way the external and/or internal factors that affect liability risk exposure, while keeping the used trigger techniques transparent. Moreover, the system is able to dynamically capture and adapt how and where risk is transferred, which will create a more efficient and correct use of risk and loss drivers in the liability insurance technology systems. Furthermore, the invention is able to provide an electronically automated, adaptive pricing tool for risk-transfers based upon liability exposure, especially for mid-size risks. As another advantage, the liability risk-driven measuring and indexing system allows for automated identification of key driving factors and their inter-dependencies. All factors are based on real measuring data. The liability risk-driven system provides in a new way a structured approach, which also allows to follow specific index validation needs. Using the system specific to formative variables, it results in a particularly comprehensive measurement index. Finally, the present invention provides an automated system, which is able to trigger and precast possible future loss ratio peaks, efficiently and correctly, and thus prevent operational failure of automated risk-transfer systems.

In addition to a system as described above and a corresponding method, the present invention also relates to a computer program product including computer program code means for controlling one or more processors of a computer system such that the computer system performs the proposed method, in particular a computer program product including a computer-readable medium containing therein the computer program code means.

### BRIEF DESCRIPTION OF THE DRAWINGS

The present invention will be explained in more detail, by way of example, with reference to the drawings, in which:

FIG. 1 shows a block diagram schematically illustrating the flow of the general liability loss ratio on an accident year basis in the US system. Despite the vast developing technology since 1995, the loss-ratio of many systems shows loss ratio peaks >120%, which is critical to the operational stability of the risk-transfer systems.

FIGS. 2A and 2B show a block diagram schematically illustrating the first set of liability risk drivers based on economic measuring factors, capturing a large proportion of the dynamic of the ultimate aggregated year liability loss progression. The magenta line gives the developed aggregated year (AY) general liability (GL) losses as % of the Gross Domestic Product (GDP), the red line gives a first-year estimate AY GL loss as % of GDP, and the yellow line shows the result received by the first set of liability risk drivers comprising GDP (Gross Domestic Product) growth, healthcare expenditure growth, and real wage growth.

FIG. 3 shows another block diagram schematically illustrating the Accident Year (AY) Liability Losses based on Schedule-P submissions, which are, for this example, directly captured from the SNL data platform provided by S&P Global Platts. In FIG. 4, for the y-variable, the losses gross of reinsurance are used as the primary y-variable based on the captured gross and net of reinsurance loss data. Further, a normalization by GDP is used to exclude the part of the economic cycle which does not add any specific information.

FIG. 4 shows the generation of the correlation matrix capturing the correlation of the different liability risk driver 311-313 pairwise.

FIG. 5 show the R² values for each of the 4095 possibilities, if 12 possible liability risk drivers 311-313 are taken and iterated over all possible combinations. For each possibility, the R² value is generated, and the number of liability risk drivers 311-313 is selected. Thus, FIG. 5 shows the reduce to the max technique according to the invention. Depending on the choice of factors, up to 94% of Y-variable variation can be explained. For example, using the technique with overall 12 factors available from the four pillars, the pillar structure can be ignored iterating over all possible combinations of (i) 1 factor (exactly 12 possibilities), (ii) 2 factors (exactly 66 possibilities) . . . (x) 12 factors (exactly 1 possibility) which overall gives 4095 possibilities. For each possibility the R² value can be generated. The system then penalises for the number of factors used which is plotted in FIG. 5 showing the R² values for each of the 4095 possibilities

FIG. 6 shows another example of the “reduce to the max” method. On the left side, there are the 12 selectable liability risk drivers 311-313, i.e. GDP growth, medical expenses growth, wage growth, education, population density, emotional factor, party control, judicial vacancies, political giving, number of lawyers, government regulations, and tort reform. As seen from FIG. 7, by selecting 7 out of the 12 selectable liability risk drivers 311-313, a R² of 89.4% can be reached for this example.

FIG. 7 show the comparison of the values of the “reduce to the max”-based system 10 and the y-variable, wherein the y-variable is the agreed-upon gross year losses based on the SNL data source, as discussed above.

FIG. 8 schematically illustrates the time-dependent flow of the 7 selected liability risk drivers 311-313 by means of the “reduce to the max” operation of the system 10, namely 1. Medical expenses growth, 2. Wage growth, 3. Population density, 4, Party control, 5. Political giving, 6. Government regulations, and 7. Tort reforms.

FIGS. 9 and 10 schematically show the smallest R² value of the corresponding regressions, and the average R² value of the corresponding regressions, in addition to the largest R² value of all regressions with a given number of liability risk drivers 311-313. In the relevant range (regressions with 6-7 liability risk drivers 311-313), the range of R² values is quite large with a very prominent maximum adds confidence to the reduce-to-the-max solution. Since only one combination of all 12 liability risk drivers 311-313 is possible, the range between the smallest and the largest R² value collapses to a single point.

FIG. 11 shows the difference of the selection of 5 liability risk drivers 311-313 compared to 7 liability risk drivers 311-313 in the AIC-approach.

FIGS. 12 and 13 schematically show, as discussed under FIGS. 10 and 11 for the R² structure, for the largest AIC value of all regressions with a given number of liability risk drivers 311-313, the smallest AIC value of the corresponding regressions, and the average AIC value of the corresponding regressions. In the relevant range, for gross losses the AIC curve for 4-7 liability risk drivers 311-313 is rather flat. For each given number of factors, the difference between different combinations is large (as illustrated by the large differences between lowest and largest values), suggesting a clear preference for the chosen set.

FIG. 14 shows a process of one of more embodiments of the present disclosure.

FIG. 15 shows a configuration of a system of the present disclosure.

### DETAILED DESCRIPTION OF THE PREFERRED EMBODIMENTS

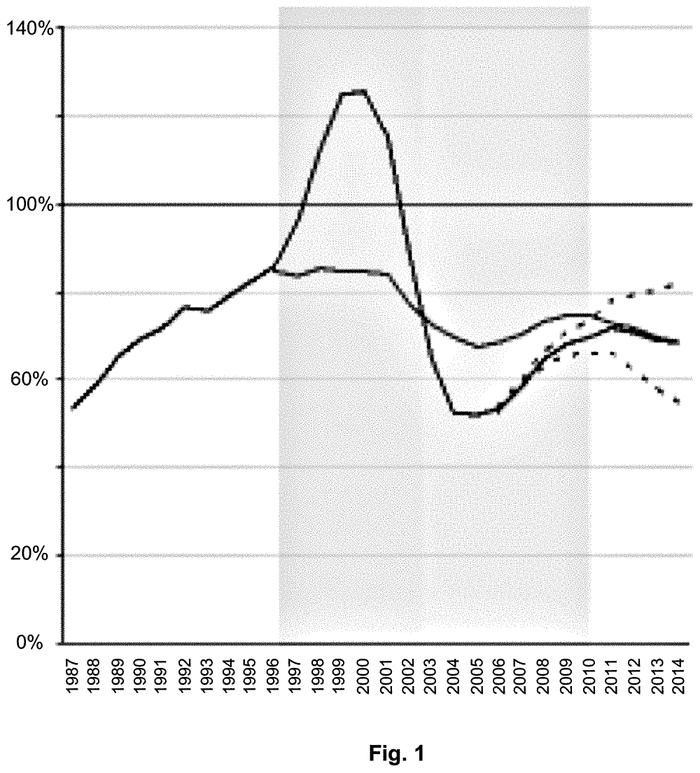

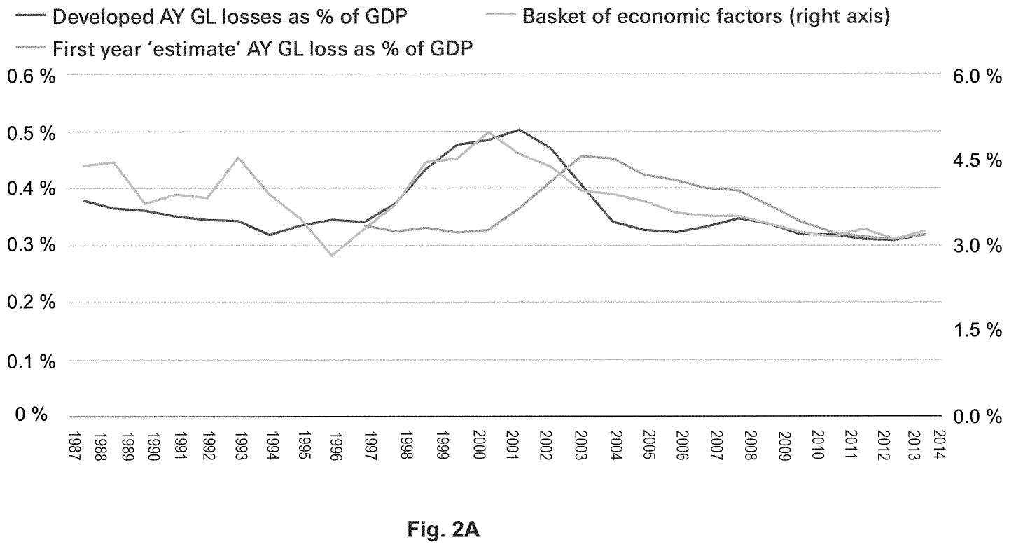

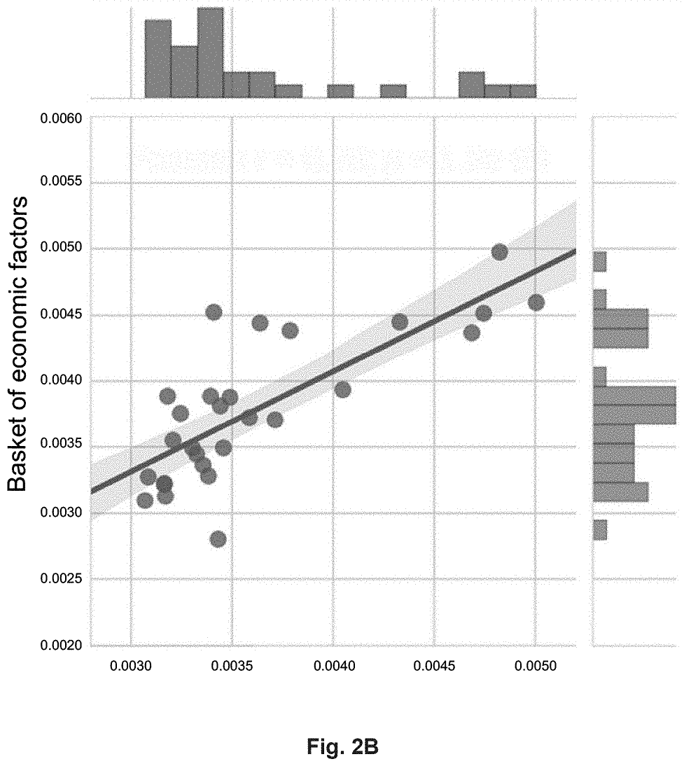

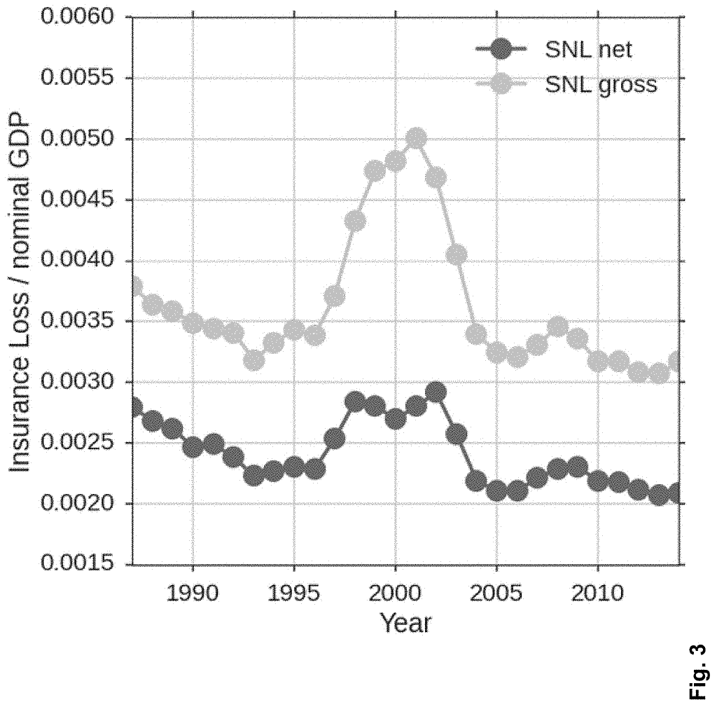

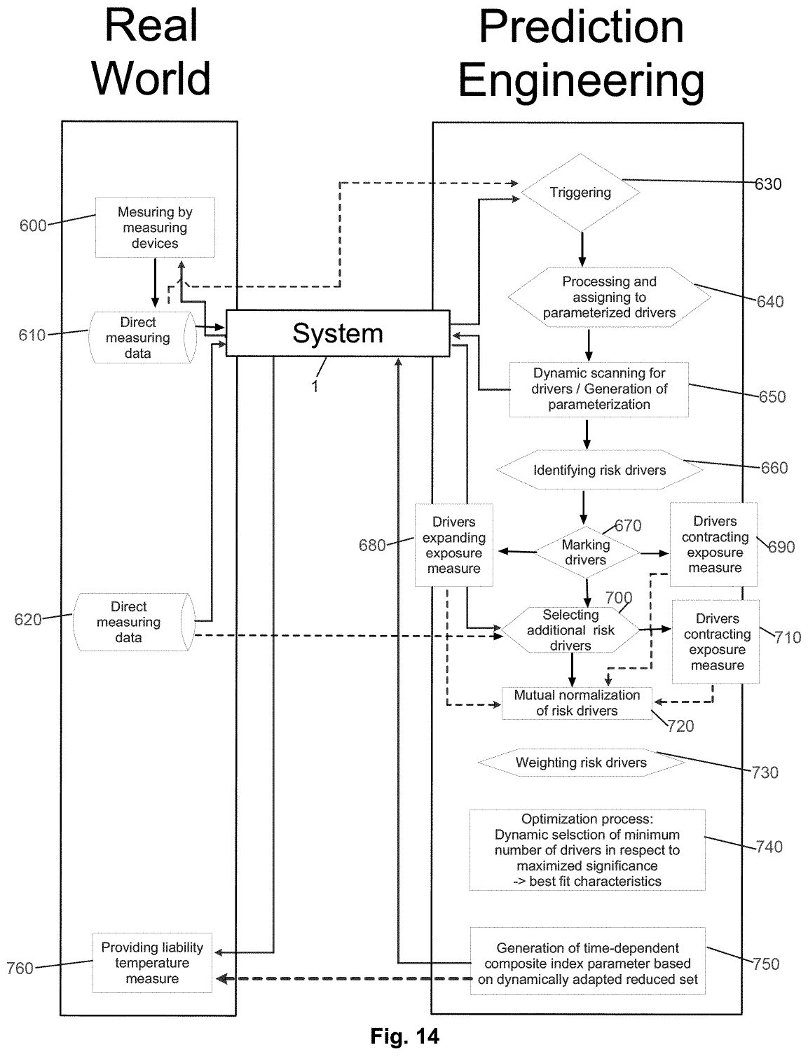

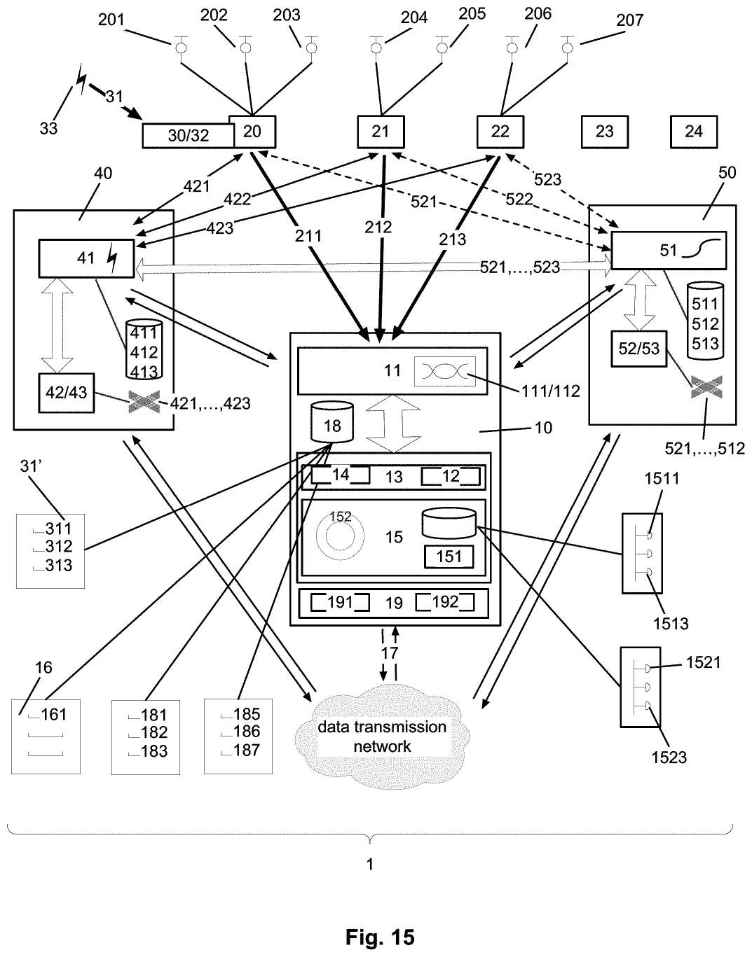

FIGS. 1 to 15 schematically illustrates a possible realization of an embodiment of the system 1/method for a liability risk driven measuring and indexing system providing automated triggering, tracking, parametrizing, modeling and forecasting developments of liability loss measures. The system 10 can for example comprise a signal generation module 11 for steering liability risk-driven interaction between an insurance unit 40 and a plurality of operating units 30 with at least one measurable liability exposure 31. Reference numeral 10 refers to the measuring and indexing system, which can also be realized as a control unit controller and which is at least partially realized as an electronic interacting device or module interacting electronically by means of appropriate signal generation between the risk-transfer system 40 and the plurality of operating units 30, all comprised in the overall system 1. The risk-transfer system or automated insurance unit 40 can comprise any kind of damage recovery modules and/or automated repair nodes. The damage recovery modules can also comprise monetary-based damage compensation, which is electronically assigned to a loss unit 20-26 with a loss caused by an operating unit 30. The risk-transfer system 40 can also comprise dedicated repair nodes comprising automatic or semiautomatic systems to maintain operation or recover loss of the loss units 20, . . . , 26 in case of loss. It must be mentioned that, for many technical applications in the risk-transfer industry, maintenance programs or liability systems are often statutory due to security reasons or protection of the consumer, etc. The operating units 30 can comprise all kinds of operating or field devices, such as device controllers, valves, positioners, switches, transmitters (e.g. temperature, pressure and flow rate sensors) or any other technical devices. An automated repair node can comprise a defined repair flow. A repair flow comprises the process flow triggered or initiated by a liability loss of a loss unit 20-26 caused by an operating unit 30, as described above, to repair or replace the loss, a technical fault or malfunction. The repair flow can also comprise financial compensation, e.g., a direct technical repair or replacement of the loss becomes impossible or the use of dedicated repair devices is not possible due to other reasons. To cover such cases of liabilities, the repair node can also comprise means to initiate data transmission for financial compensation. It can be useful for the repair nodes to comprise or have access to tracking systems of loss on the loss units 20, . . . , 26. Normally, operating units 30 are assigned to a user or a firm or are at least representing a user or a firm. However, each operating unit 30 has at least one measurable risk or exposure for arising liability to a loss unit 20-26. In addition, the predictive, liability risk-driven system 10 can comprise one or more data processing units, displays and other operating elements such as keyboards and/or pointing devices. The measuring and indexing system 10 as well as the operating units 30 and the risk-transfer system 40 comprise functional modules, such as the signaling module 11 for signal generation and transmission 111, a central processing device 13, signal transmission interface 14/32/41, a driver selector 15, electronic data repository units or data storages 18 and/or liability risk drivers 311-313. A person skilled in the art will understand by viewing the specification that these functional modules are realized at least partially as hardware components. However, a person skilled in the art will also understand that the functional modules can be implemented at least in part by means of dedicated software modules. Furthermore, the reference numerals 14/32/41 refer to signal transmission interfaces which can be connected directly or over a data transmission network. Therefore, the liability risk-driven system 10 and/or the operating unit 30 and/or the risk-transfer system 40 and/or the loss units 20-26 and/or the measuring devices 201, . . . , 261 can be connected via a network for signal transmission. The network can for example comprise a telecommunication network as a wired or wireless network, e.g. the Internet, a GSM-network (Global System for Mobile Communication), a UMTS-network (Universal Mobile Telecommunications System) and/or a WLAN (Wireless Local Region Network), a Public Switched Telephone Network (PSTN) and/or dedicated point-to-point communication lines. The liability risk-driven system 10 and/or the operating unit 30 and/or the risk-transfer system 40 and/or the loss units 20-26 and/or the measuring devices 201, . . . , 261 can also comprise a plurality of interfaces to connect to the communication network according to the transmission standard or protocol.

At least one measurable liability exposure 31 is assigned to each of the plurality of operating units 30. Each liability exposure 31 can be represented by means of a liability risk driver 311-313. Reference numeral 31 depicts the liability exposure of the “real world”, while reference numeral 31′ stands for the liability exposure based on the risk drivers 311-313 generated by the liability risk-driven system 10. The liability risk drivers 311-313 are realized as hardware- and/or software-based functional modules interacting electronically with the signal generation of the liability risk-driven system 10. The liability risk-driven system 10 can comprise means to activate the risk-transfer system 40 in case of a loss occurring at a loss unit 20, . . . , 26 induced by an operating unit 30 and the risk-transfer system 40 can comprise automated damage recovery means to resolve the loss. Measurement parameters 610 associated with the liability risk drivers 311-313 are measured 600 and transmitted to a central processing device 13 of the liability risk-driven system 10 and the operational interaction is adapted by means of the central processing device 13. The liability risk-driven system 10 can comprise a trigger module 630 to scan measuring devices 201, . . . , 261 assigned to the loss units 20, . . . , 26 for measurement parameters and to select measurable measurement parameters 640 capturing or partly capturing 650 a process dynamic and/or static characteristic of at least one liability risk driver 311-313 by means of the liability risk-driven system or controller 10.

The liability risk-driven system 10 dynamically provides a liability risk measurement 31 by means of time-dependent, composite indexing 750 of an index parameter 17, by a time-dependent composite index, wherein, herein, the composite index is to be understood as a grouping of factors combined in a standardized way. The composite index is also used here making it possible to give a summarizing measure of the complex and multidimensional data and redundant measurements, respectively. The liability risk-driven system 10 is able to steer the liability risk-driven interaction between the automated risk-transfer system 40 and the plurality of risk-exposed units 30 having at least one measurable liability exposure 31. As mentioned, in case of a loss occurring at a loss unit 20, . . . , 26 induced by a risk-exposed unit 30, the automated risk-transfer system 40 is activated by signaling of the liability risk-driven system 10 and the loss is automatically resolved by means of the risk-transfer system 40. Measurement parameters to be assigned to the liability risk drivers 311-313 are measured 600 by means of the liability risk-driven system 10 and transmitted to a central processing device 13 of the liability risk-driven system 10. The operational interaction is dynamically adaptable by means of the central processing device 13.

The measuring devices 201, . . . , 206 or repository units 18 assigned to the loss units 20, . . . , 26 are scanned dynamically or on request for measurement parameters 211, . . . , 216 capturing dynamic and/or static characteristics of at least one liability risk driver 311-313. Impacting liability risk drivers 311-313 are automatically identified 660 and marked 670 by means of the liability risk-driven system 10, wherein the selected liability risk driver 311-313 either contract 690/710 or expand 680 the measured liability risk exposure 31.

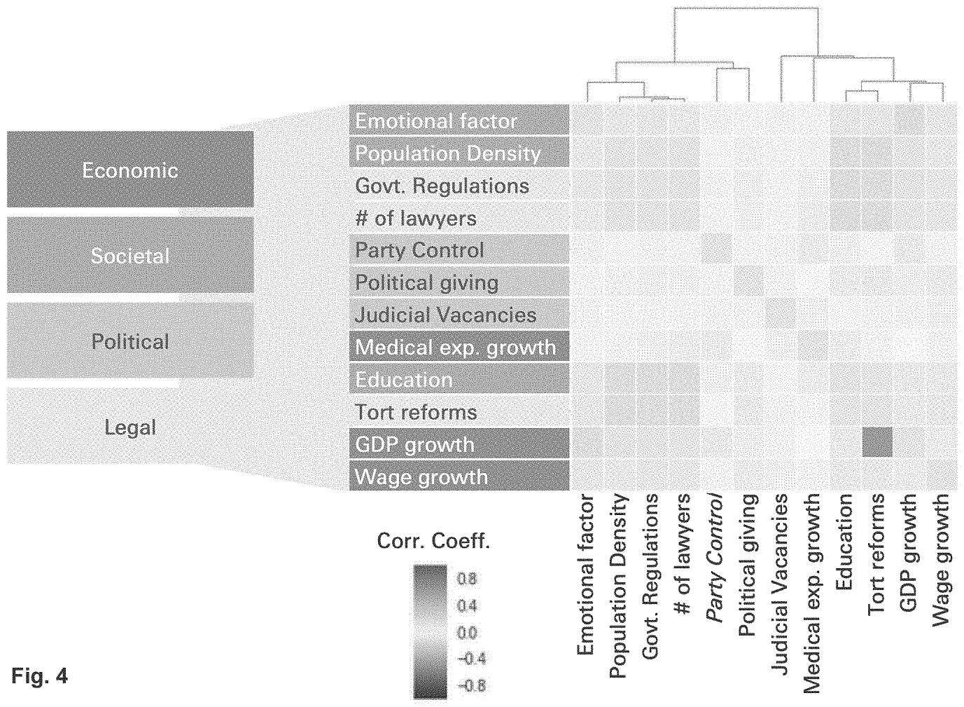

As shown in FIG. 4, a first set 16 of liability risk drivers 311-313 is selected by means of a driver selector 15 of the liability risk-driven system 10 parametrizing a progression of the general liability exposure loss 31. Said first set of liability risk drivers 311-313 at least comprise a Gross Domestic Product (GDP) growth parametrizing economic liability risk drivers 311-313, a health care expenditure growth parametrizing economic liability risk drivers 311-313, and a real wage growth parametrizing economic liability risk drivers 311-313 based on the impact of captured alterations to the variable composite index parameter. The system 10 mutually normalizes 720 the liability risk drivers 311-313 to each (e.g. pairwise). To normalize 720, the impacts of the different liability risk drivers 311-313 can for example be scaled to the same scale by applying, as normalization, the transformation to a final time series x_{†}=[x_{†}-min_{t′}(x_{t′})]/[max_{t′}(x_{t′})−min_{t′}(x_{t′})].

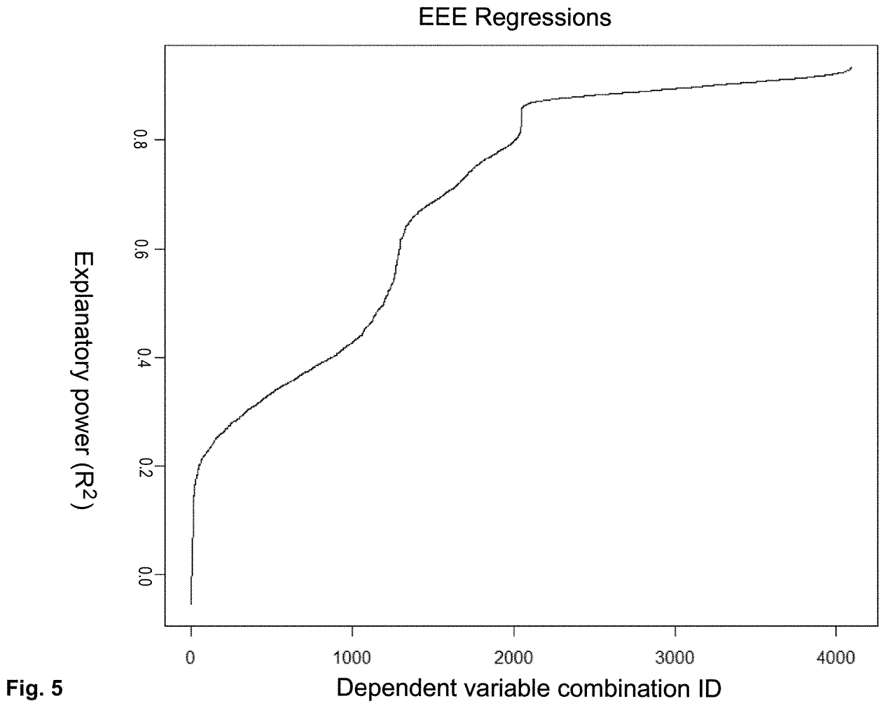

FIG. 4 shows the first set of liability risk drivers based on economic measuring factors, capturing a large proportion of the dynamic of the ultimate aggregated year liability loss progression. The magenta line gives the developed accident year (AY) general liability (GL) losses as % of the Gross Domestic Product (GDP), the red line gives a first-year estimate AY GL loss as % of GDP, and the yellow line shows the result received by the first set of liability risk drivers comprising GDP (Gross Domestic Product) growth, healthcare expenditure growth, and real wage growth. FIG. 5 shows Accident Year (AY) Liability Losses based on Schedule-P submissions, which are, for this example, directly captured from the SNL data platform provided by S&P Global Platts. The Schedule P is a program and financing schedule based on the annual data flow of the US government, called Annual Statement. It comprises data on agency programs, the allocation of budgetary resources by activity, the status of those resources, and spending patterns. Thus, the Schedule P are annual statutory filings of all insurance companies writing business in the US. Schedule P is designed to measure loss and loss adjustment expense reserve adequacy, both retrospectively and prospectively. It comprises a retrospective test, by accident year and line of business, of reserves held in prior years. Schedule P provides data which make it possible to generate the excess statutory reserves over statement reserves for four lines of business: Automobile Liability (Personal and Commercial), Other Liability, Medical Malpractice, and Workers' Compensation. It gives both direct and net experience, to evaluate the effects of reinsurance recoveries on accident year loss ratios by line of business. It gives data for payments and reserves for losses and loss adjustment expenses by accident year. In FIG. 5, for the y-variable, the losses gross of reinsurance are used as the primary y-variable based on the captured gross and net of reinsurance loss data. Further, a normalization by GDP is used to exclude the part of the economic cycle which does not add any specific information.

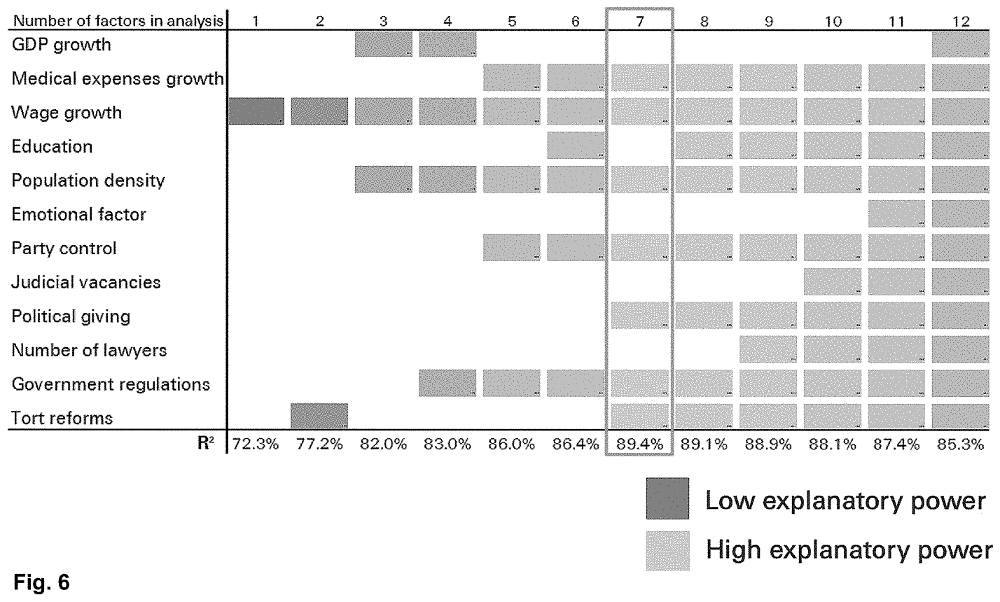

Additional liability risk drivers 311-313 are selected 700 by means of the driver selector 15 comprising at least societal and/or legal and/or political alteration induced liability risk drivers 311-313, wherein the system 10 dynamically selects appropriate liability risk drivers 311-313 parameterizing the impact of captured alterations to the variable composite index parameter and normalizing 720 the liability risk drivers 311-313 to each. FIG. 6 shows the generation of the correlation matrix capturing the correlation of the different liability risk driver 311-313 pairwise.

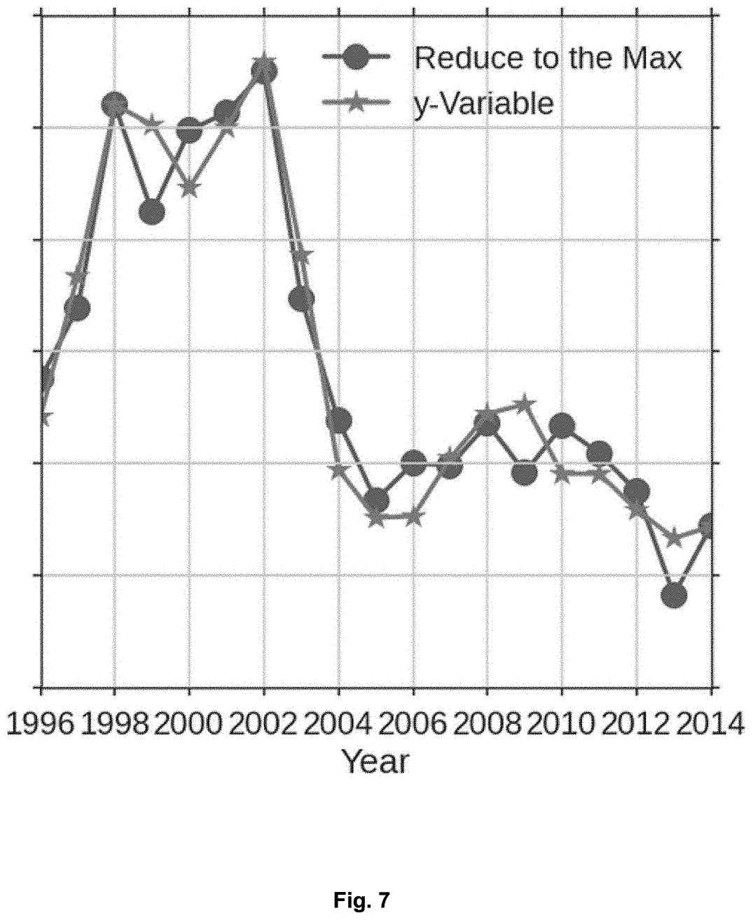

For normalizing 720 of the selected liability risk drivers 311-313, a defined transformation 151 is applied to the final time series of the parameters by means of the driver selector 15 providing 730 individual set weights 1511, . . . , 1513 and/or individual driver weights 1521, . . . , 1523. Based on the weighted liability risk drivers 311-313 and sets of liability risk drivers 311-313, a minimum number 192 of liability risk drivers 311-313 in relation to maximized statistical significance is selected 740 by applying an index assembly and validation unit 19. The index assembly and validation unit 19 provides 740 the minimum number 192 of liability risk drivers 311-313 as a reduced set 161 of liability risk drivers out of all available liability risk drivers 16 using best fit characteristics 191. This process is called herein “reduce to the max”. Reduce to the max strongly depends on the choice of factors. By means of the present system 10, up to 94% of Y-variable variation can be captured based on 6 liability risk drivers 311-313. For the example of FIG. 7, 12 liability risk drivers 311-313 are used. Iterating over possible combinations of the liability risk drivers 311-313 (1 factor (exactly 12 possibilities); 2 factors (exactly 66 possibilities) . . . 12 factors (exactly 1 possibility)), there are 4095 possibilities overall. For each possibility, the R² value is generated, and the number of liability risk drivers 311-313 is selected. FIG. 7 show the R² values for each of the 4095 possibilities.

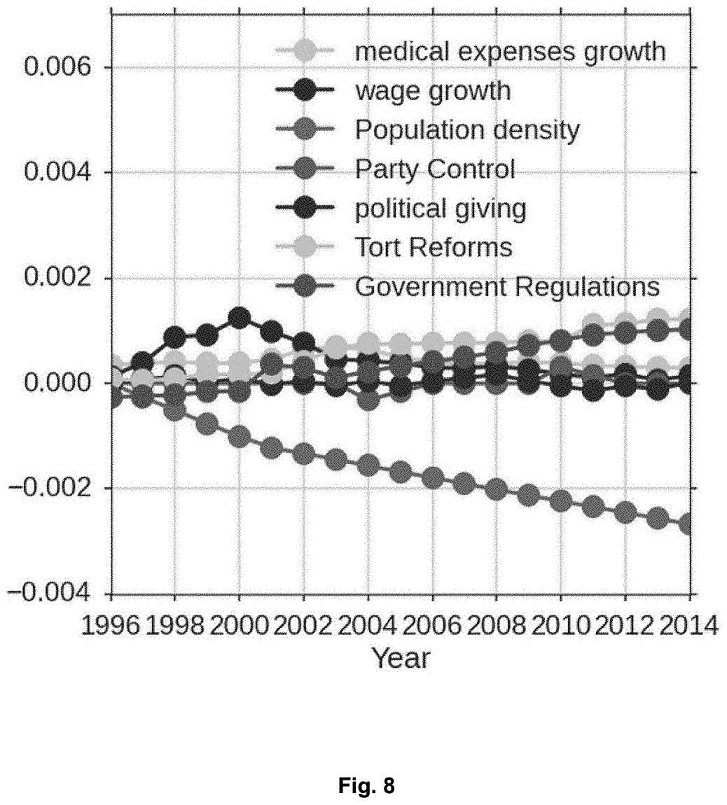

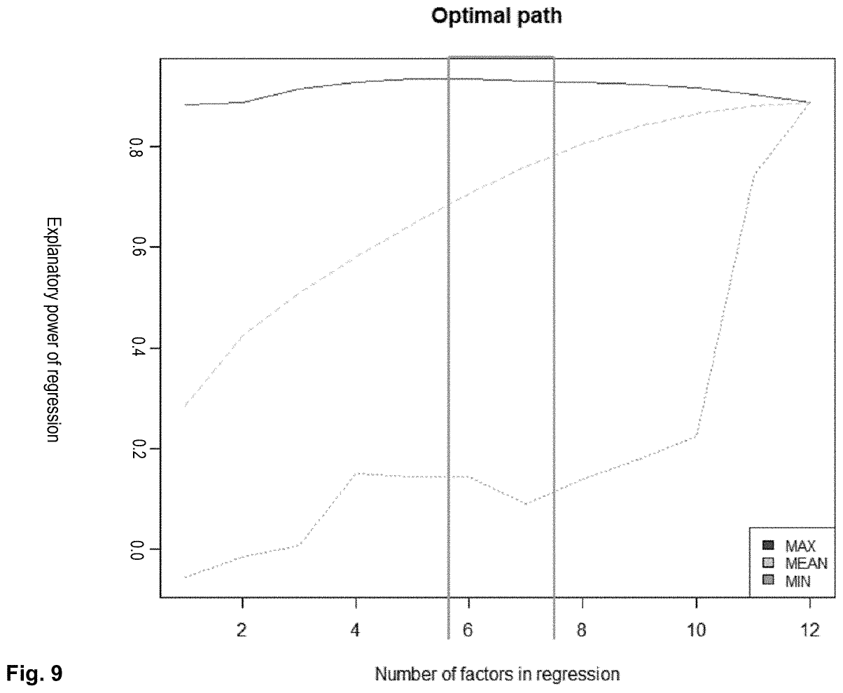

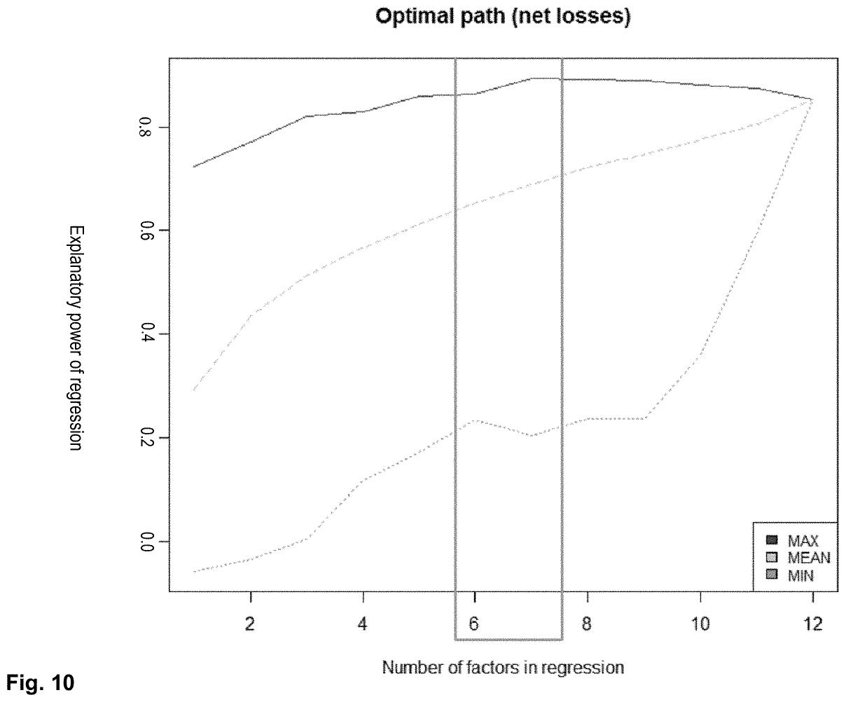

FIG. 8 shows another example of the “reduce to the max” method. On the left side, there are the 12 selectable liability risk drivers 311-313, i.e. GDP growth, medical expenses growth, wage growth, education, population density, emotional factor, party control, judicial vacancies, political giving, number of lawyers, government regulations, and tort reform. As seen from FIG. 8, by selecting 7 out of the 12 selectable liability risk drivers 311-313, a R² of 89.4% can be reached for this example. All 7 are statistically significant, i.e. 1. Medical expenses growth, 2. Wage growth, 3. Population density, 4, Party control, 5. Political giving, 6. Government regulations, and 7. Tort reforms, and give the optimal selection for the gross loss fitting. FIG. 9 shows the comparison of the values of the “reduce to the max”-based system 10 and the y-variable, wherein the y-variable is the agreed-upon gross year losses based on the SNL data source, as discussed above. Finally, FIG. 10 illustrates the time-dependent flow of the 7 selected liability risk drivers 311-313 by means of the “reduce to the max” operation of the system 10, namely 1. Medical expenses growth, 2. Wage growth, 3. Population density, 4, Party control, 5. Political giving, 6. Government regulations, and 7. Tort reforms.

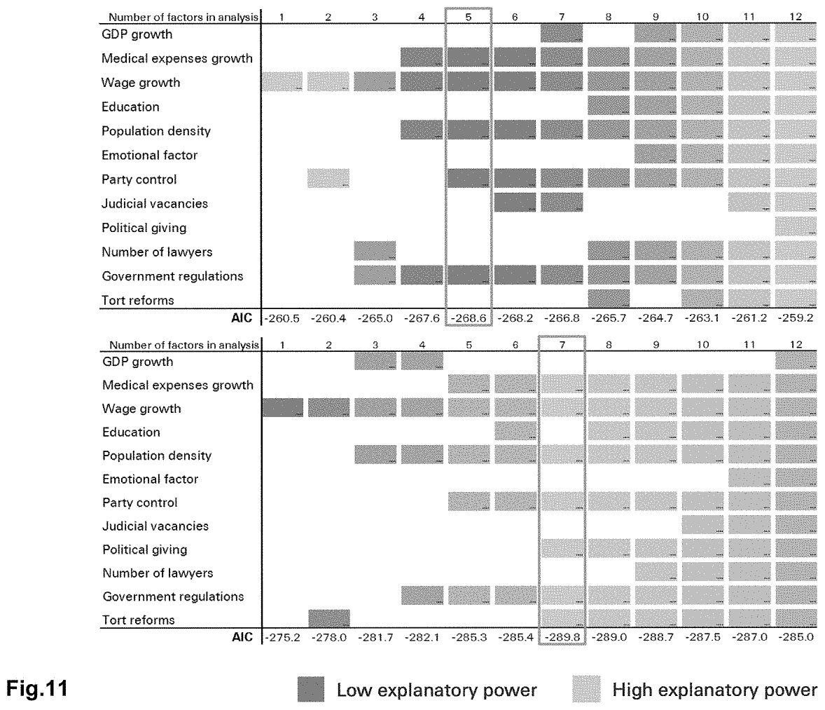

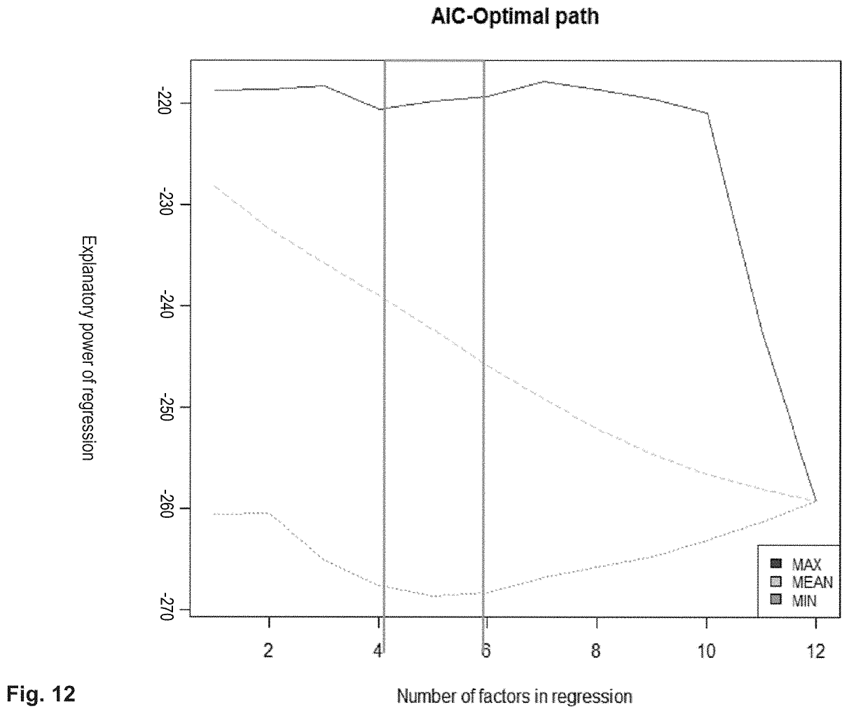

When using the maximisation procedure of the system 10, such as choosing 740 the smallest number of liability risk drivers 311-313 providing the “best” indexing—it is important to have a clear view on the stability of the solution. In the case that all values are close to each other, a choice made based on the largest value might not be very clear. In addition to the largest R² value of all regressions with a given number of liability risk drivers 311-313, FIGS. 11 and 12 show the smallest R² value of the corresponding regressions, and the average R² value of the corresponding regressions. In the relevant range (regressions with 6-7 liability risk drivers 311-313), the range of R² values is quite large with a very prominent maximum which adds confidence to the reduce-to-the-max technique. Since only one combination of all 12 liability risk drivers 311-313 is possible, the range between the smallest and the largest R² value collapses to a single point.

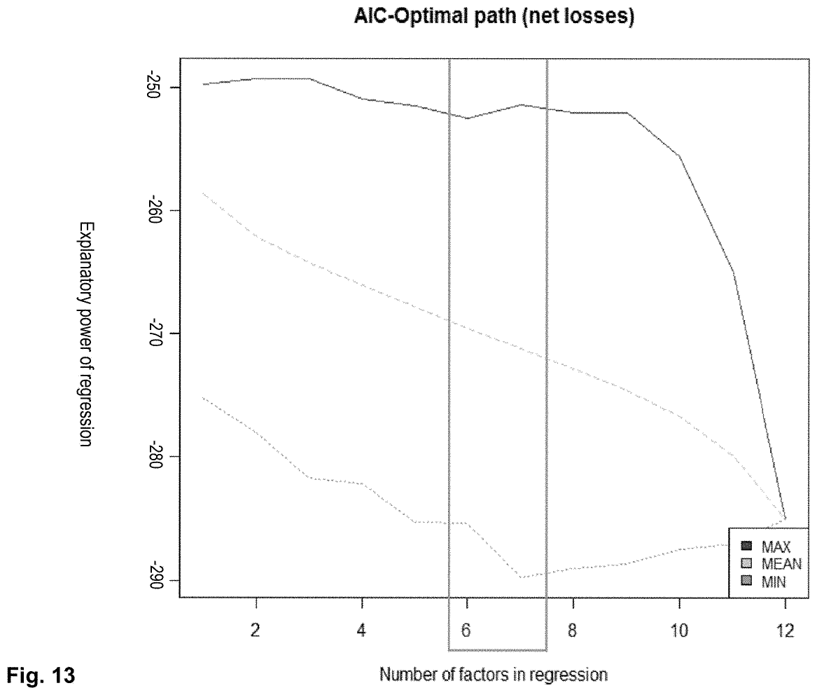

As another embodiment variant, for the applied “reduce-to-the-max” structure to find the best modelling for a given dataset, using R² is one option. As a variant, it is also possible to apply the so-called “Akaike Information Criterion”. For gross losses, the AIC structure applies the five-liability risk drivers 311-313 approach as the best. Based on the R²-structure, the six-liability risk drivers 311-313 approach is selected (adding “Judicial vacancies”). However, the sets of liability risk drivers 311-313 are the same, and the difference between the R² and AIC values for these two approaches is rather small. Going from 5 to 6 factors, the difference is, for R², going up from 93.4% to 93.5%, and for AIC, going up from −268.6 to −268.2. For net losses, the AIC approach leads identically to the same solution as the one based on R². Moreover, the set of liability risk drivers 311-313 suggested by this approach for all models (using 1, 2, . . . , 12 liability risk drivers 311-313) is the same as what was suggested by the R²-based approach. FIG. 13 shows the difference between the selection of 5 liability risk drivers 311-313 and 7 liability risk drivers 311-313 in the AIC-approach. Also, when applying the AIC-approach, if using the maximisation procedure of the system 10, such as choosing the smallest number of liability risk drivers 311-313 providing the “best” indexing, it is important to have a proper view on the stability of the solution. Analogously, as discussed above for the R² structure, for the largest AIC value of all regressions with a given number of liability risk drivers 311-313, the FIGS. 12 and 13 show the smallest AIC value of the corresponding regressions, and the average AIC value of the corresponding regressions. In the relevant range, for gross losses, the AIC curve for 4-7 liability risk drivers 311-313 is rather flat. For each given number of factors, the difference between different combinations is large (as illustrated by the large differences between lowest and largest values), suggesting a clear preference for the chosen set.

As an embodiment variant, for example, 4 sets of liability risk drivers 311-313 can be applied with 18 different liability risk drivers 311-313 overall. An economic set of liability risk drivers 311-313, as a first set, can for example comprise (i) a GDP growth liability risk driver 311-313 (nominal and real, (y-o-y)), (ii) a medical expenses liability risk driver 311-313, (iii) a consumer price index (CPI) inflation liability risk driver 311-313 ((y-o-y), core inflation), and (iv) an hourly wage growth (y-o-y) liability risk driver 311-313. GDP is the broadest metric for economic activity and therefore a general driver for liability exposure growth. (1) Real GDP growth is more geared toward frequency; (2) nominal GDP drives frequency and severity. It may serve as a hypothesis that higher real GDP growth leads to higher claims frequency. The medical expenses liability risk driver 311-313 is the key driver for bodily injury claims severity. More than half of general liability claims relate to bodily injuries. It may serve as a hypothesis that more HCE growth leads to higher claims inflation. CPI is used as a general metric for the price of goods and services and therefore driver for claims severity. Core inflation (ex food and energy) should be the better fit with claims inflation, since food and energy are not typically related to claims awards. It may serve as a hypothesis that more CPI/core inflation leads to higher claims inflation. Finally, concerning the hourly wage growth liability risk driver 311-313, wage inflation is the key driver for bodily injury claims severity (1) via loss of income, (2) as a main component of healthcare expenditures, and (3) as a driver of general repair costs. It may serve as a hypothesis that higher wage growth leads to higher claims severity.

As a second set of liability risk drivers 311-313, a political set may be applied parametrizing political triggered impacts. The political set can for example comprise (i) a liability risk driver 311-313 for the number of political parties holding all chambers in the legislature and executive seat, whereas full party control (only one party) facilitates more frequent passage of laws, (ii) an overall judicial vacancies liability risk driver 311-313, whereas lack of judges results in fewer cases being adjudicated, and (iii) a liability risk driver 311-313 parametrizing the increased giving by relevant stakeholders (e.g. Trial Bar Associations, US Chamber ILR), whereas increased political giving suggests a spike in interest in a certain topic.

As a third set of liability risk drivers 311-313, a legal set may be applied parametrizing legally triggered impacts. The legal set can for example comprise a liability risk driver 311-313 triggering (i) the number of practicing lawyers, (ii) total tort filings, (iii) access costs/barriers, (iv) increased/decreased government regulation, (v) class action rules changing over time, and (vi) attorney advertising. It is to be noted that (i) More lawyers mean more lawyers looking for ways to ‘create’ income, thus more lawyers causing more litigation, more filings, more losses . . . . It is also to be noted that the lawyer demographic data may make it possible to test this when boomer lawyers retire; (ii) Increases in tort filings (frequency) causes increased loss patterns. The cause may be, that the sheer incidence of frequency likely precipitates greater losses. This is not always a frequency/severity correlation, but it can be expected to be so; (iii) The decision to pursue litigation is caused, in part, by the total costs to finance litigation; as costs go up; this will deter certain categories of litigation. There is a cost/benefit analysis that must making filing appear financially prudent at the outset. Higher costs are a deterrent relative to damage models; (iv) Increased government regulation leads to more litigation because non-compliance creates new causes of action. Further, an attempt to track sub-topical litigation trends (i.e. tracking regulatory change) could be a marker against total filings; (v) Access to Class action/hurdles to class certification; movement to MDL framework; and (vi) Typically, increasing advertising is a barometer for increased tort litigation. Decreasing advertising should show a decrease in litigation. However, as advertising mediums change, it is difficult to isolate and trigger transition to new mediums from total spend. In addition, increased advertising could simultaneously increase litigation and/or merely competitively increase the cash entry threshold for attorneys themselves to participate in the total set of litigation available.

As a fourth set of liability risk drivers 311-313, a social set may be applied parametrizing socially triggered impacts. The social set can for example comprise a liability risk driver 311-313 triggering (i) Perception of fault, (ii) Duration (salience of claim), (iii) Population density, (iv) Education, (v) Income. It is to be noted that (i) Those who blame others are more likely to file claims (propensity to sue), and it is likely to be driven by the relative size of claim compared to their income; (ii) A claim/situation which involves long-term damage, which will serve as a frequent reminder, may be more likely to drive suing behaviour than a shorter-term damage (e.g. Temporary vs. Permanent disability), influencing propensity to sue; (iii) Higher population density, captured by urbanization, implies more exposure to torts (slips and falls, med mal, products liability, employer's liability etc.), lawyers' advertising and media generally, facilitating easier access to legal system (higher concentration of legal services, proximity of courts); (iv) Studies by the National Economic Research Associates (NERA) show that those with lower levels of education are more likely to sue (higher frequency of claims) as compared to those with higher levels of education. However, once a claim is made, those with higher education are more likely to successfully carry the claim through because of easier access to the legal system, increasing the severity of a claim. The education factor captures a key behavioural component of an individual's propensity to sue. It is to be noted that there is a non-negligible link between education levels and income; and (v) Claimants with lower income are more likely to claim (cf. NERA) due to their being more susceptible/vulnerable to plaintiff lawyers' advertisement (commercialization of law) as well as their lower opportunity cost of time. On the other hand, claimants with higher income are more likely to claim if the financial wrong they endured is high enough: they have the means to afford counsel (access to the legal system). They also have a higher likelihood of having insurance coverage, enabling claiming behaviour.

In the present invention, the minimum number 192 of liability risk drivers 311-313 is dynamically adapted by means of the driver selector 15, thereby varying the liability risk drivers 311-313 in relation to the measured liability exposure signal 31 by periodic time response. The time-dependent composite index parameter 17 is generated 750 based on the adapted reduced set 161 of liability risk drivers 311-313 by means of the liability-risk driven system 10. The liability risk-driven interaction between the risk-transfer system 40 and the operating unit 30 is adjusted based upon the time-dependent composite index parameter 17. The driver selector 15 can for example dynamically adapt the reduced set 161 of liability risk drivers 311-313 varying the liability risk drivers 311-313 in relation to the measured liability exposure signal 31 by periodic time response, wherein the liability risk-driven system 10 comprises an interface module 14 to transmit a request for a measurement parameter update 112 periodically to the measuring devices 201, . . . , 261 for dynamic detection of variations of the measurement parameters. Furthermore, the liability risk-driven interaction between the automated risk-transfer system 40 and the operating unit 30 can for example be adjusted dynamically based upon the adapted liability exposure signal 31, wherein the automated risk-transfer system 40 is activated by the liability risk-driven system 10, and if the risk-transfer system 40 is activated by the liability risk-driven system 10, an automated repair node assigned to the risk-transfer system 40 is activated by means of appropriate signal generation and transmission to resolve the loss of the loss unit 20, . . . , 26.

### LIST OF REFERENCE SIGNS

1 Liability-loss dependent system
10 Predictive, liability risk-driven system
11 Signaling module
111 Signal generation and transmission
112 Request for measure parameter update
12 Interaction between insurance unit and operating units
13 Central processing device
14 Signal transmission interface
15 Driver selector
151 Defined transformation
1511, . . . , 1513 Individual set weights
1521, . . . , 1523 Individual driver weights
152 Index assembly and validation unit
16 Sets of liability risk drivers
161 Reduced set of liability risk drivers
17 Time-dependent composite index parameter
18 Repository units
181, . . . , 183 Dedicated data storages with region-specific data
185, . . . , 188 Dedicated data storages with historic data
19 Index assembly and validation unit
191 Best fit characteristics
192 Minimum number of liability risk drivers
20-26 Loss units
201, . . . , 206 Measuring devices
211, . . . , 216 Measure parameters
30 Risk-exposed components
31 Liability exposure (real world)
311-313 Liability risk drivers
31′ Liability exposure based on the risk drivers 311-313 of the controller 10
32 Signal transmission interface
33 Risk event
40 Automated risk-transfer system
41 Signal transmission interface
411, . . . , 413 Risk transfer parameters
42 Payment transfer modules
421, . . . , 423 Payment transfer parameters
43 Automated first resource pooling system
50 Automated second risk-transfer system
51 Signal transmission interface
511, . . . , 513 Risk transfer parameters
52 Payment transfer modules
521, . . . , 523 Payment transfer parameters
53 Automated second resource pooling system

1. An electronic system measuring and dynamically parametrizing a liability temperature measure for a liability system by providing an accurate liability risk measure based on a time-dependent, composite index parameter, wherein measurement parameters assigned to parameterized liability risk drivers are measured and transmitted to a central processing device of the electronic system for generating the measured time-dependent, composite index parameter, the electronic system comprising:
processing circuitry configured to
scan the liability system for the measurement parameters capturing dynamic and/or static characteristics of at least one liability risk driver of the parameterized liability risk drivers, and identify and mark liability risk drivers, the identified and marked liability risk driver either contracting or expanding the liability risk exposure,
select a first set of liability risk drivers by parametrizing an economic-based contribution to a general liability exposure loss, wherein the first set of liability risk drivers at least comprises a risk driver parametrizing Gross Domestic Product (GDP) growth, a risk driver parametrizing healthcare expenditure growth, and a risk driver parametrizing real wage growth based on an impact of captured alterations to the variable composite index parameter, the liability risk drivers being mutually normalized to each other, and
select additional liability risk drivers by parametrizing at least societal and/or legal and/or political based contributions to the general liability exposure loss, dynamically apply the additional liability risk drivers based on their impact to the measured variable composite index parameter, and dynamically normalize the liability risk drivers to each other, wherein
the processing circuitry is configured to apply a defined transformation to normalize the selected liability risk drivers, to the final time series of the parameters by providing individual set weights and/or individual driver weights,
the processing circuitry is configured to, based on the weighted liability risk drivers and sets of liability risk drivers, select a minimum number of liability risk drivers in relation to maximized statistical significance, and provide the minimum number of liability risk drivers as a reduced set of liability risk drivers out of all available liability risk drivers using best fit characteristics, and
the processing circuitry is configured to adapt dynamically the minimum number of liability risk drivers varying the liability risk drivers in relation to the measured liability exposure signal by periodic time response, and generate the time-dependent composite index parameter based on the adapted reduced set of liability risk drivers, a liability risk-driven interaction between a risk-transfer system and an operating device being adjusted based upon the time-dependent composite index parameter.

2. The electronic system according to claim 1, wherein impacts of the different liability risk drivers are scaled to a same scale by applying as normalization the transformation to a final time series x_{†}=[x_{†}-min_{t′}(x_{t′})]/[max_{t′}(x_{t′})−min_{t′}(x_{t′})].

3. The electronic system according to claim 1, wherein to select the minimum number of liability risk drivers in relation to maximized statistical significance based on the weighted liability risk drivers and sets of liability risk drivers, the processing circuitry is configured to apply R²-maximization compared to a number of selected liability risk drivers.

4. The electronic system according to claim 1, wherein to select the minimum number of liability risk drivers in relation to maximized statistical significance based on the weighted liability risk drivers and sets of liability risk drivers (311-313), the processing circuitry is configured to apply Akaike Information Criterion (AIC)-maximization compared to a number of selected liability risk drivers.

5. The electronic system according to claim 1, wherein the processing circuitry is configured to dynamically adapt the first set of liability risk drivers varying the liability risk drivers in relation to the measured liability exposure signal by periodic time response, and transmit a request for a measurement parameter update periodically to measuring devices for dynamic detection of variations of the measure parameters.

6. The electronic system according to claim 1, wherein the processing circuitry is configured to automatically provide appropriate signaling for dynamic steering of the liability risk-driven interaction between liability-dependent, automated devices.

7. The electronic system according to claim 6, wherein the liability-dependent, automated devices are realized as automated risk-transfer systems or as automated risk-transfer systems electronically interacting with a plurality of risk-exposed units with at least one measurable liability exposure, wherein in response to an occurring loss at a loss unit induced by a risk-exposed unit, the automated risk-transfer system is activated by signaling of the electronic system and the loss is automatically resolved by the risk-transfer system.

8. The electronic system according to claim 7, wherein the liability-dependent, automated devices are automated risk-transfer systems or automated insurance systems, wherein operation of the automated systems is adapted based on the measured time-dependent, composite index parameter accounting peaks in time-dependent fluctuations of the measurement parameters assigned to the automated risk-transfer systems.

9. The electronic system according to claim 1, wherein the processing circuitry is configured to, for capturing dynamic and/or static characteristics of at least one liability risk driver, scan measuring devices or memories assignable to loss units of the electronic system for measurement parameters capturing dynamic and/or static characteristics of at least one liability risk driver.

10. The electronic system according to claim 7, wherein the liability risk-driven interaction between the automated risk-transfer system and the operating device is adjusted based upon the adapted liability exposure signal, wherein the automated risk-transfer system is activated by the electronic system, and when the risk-transfer system is activated by the electronic system, an automated repair node assigned to the automated risk-transfer system is activated by appropriate signal generation and transmission to resolve the loss of the loss unit.

11. The electronic system according to claim 9, wherein the measurement parameters of at least one of the liability risk drivers are generated based on saved historic data in a memory of the memories, when one or more measurement parameters are not scannable for a liability risk driver of the operating device by the electronic system.

12. The electronic system according to claim 1, wherein historic exposure and loss data assigned to a geographic region are selected from a dedicated data storage comprising region-specific data, and historic measurement parameters are generated corresponding to the selected measurement parameters and the liability exposure signal is weighted by the historic measurement parameters.

13. The electronic system according to claim 5, wherein the measuring devices comprise a trigger module triggering variation of the measurement parameters and transmitting detected variations of one or more measurement parameters to the electronic system.

14. The electronic system according to claim 7, wherein when the risk-transfer system is activated by the electronic system, the risk-transfer system unlocks an automated repair node assigned to the risk-transfer system by appropriate signal generation and transmission to resolve the loss of the loss unit.

15. The electronic system according to claim 1, wherein the processing circuitry is configured to automatically capture and automatically aggregate measured loss parameters over all risk-exposed units via appropriate interface modules and an appropriate data transmission network.

16. The electronic system according to claim 7, wherein risk exposure units are connected to the automated risk-transfer system by payment transfer modules configured to receive and store payment transfer parameters from the risk exposure units for transfer of risks associated with the risk exposure units from the risk exposure units to the risk-transfer system.

17. The electronic system according to claim 7,
wherein the risk-exposed units are connected to the automated risk-transfer system transferring risk exposure associated with occurrence of defined risk events from the risk-exposed units to the automated risk-transfer system by equitable, mutually aligned risk transfer parameters and correlated aligned payment transfer parameters,
wherein the automated risk-transfer system is connected to a second risk-transfer system and transfers at least parts of the risk exposure associated with the occurrence of the defined risk events from the risk-transfer system to the second risk-transfer system by equitable, mutually aligned second risk transfer parameters and correlated aligned second payment transfer parameters,
wherein, in response to occurrence of one of the defined risk events, loss parameters measuring the loss at the risk-exposed units are captured and transmitted to the automated risk-transfer system, and
wherein the loss is automatically covered by the automated risk-transfer system based on the equitable, mutually aligned risk transfer parameters.

18. The electronic system according to claim 7, in response to the occurrence of one of the defined risk events, loss parameters measuring the loss at the risk-exposed units are captured and transmitted to the automated risk-transfer system, the loss being automatically covered by the automated risk-transfer system.

19. The electronic system according to claim 17, wherein the automated risk-transfer system is connected to the second risk-transfer system by payment transfer modules configured to receive and store second payment parameters from the automated risk-transfer system for the transfer of risks associated with the risk exposures of the risk-exposed units from the automated risk-transfer system to the second risk-transfer system.

20. The electronic system according to claim 19, wherein the processing circuitry is configured to capture a payment transfer from the automated risk-transfer system to the payment transfer modules, wherein the second risk-transfer system is only activatable by triggering a payment transfer matching a predefined activation control parameter.

21. The electronic system according to claim 7,
wherein a loss associated with the one of the defined risk events and allocated to the risk-exposed units is covered distinctly and/or separately by an automated first resource pooling system of the automated risk-transfer system via a transfer of payments from the automated first resource pooling system to the risk-exposed units, and
wherein a second payment transfer from an automated second resource pooling system of the second risk-transfer system to the automated first resource pooling system is triggered via the generated activation signal based on the measured actual loss of the risk-exposed units by the processing circuitry.

22. A measuring and indexing method for an electronic system measuring and dynamically parametrizing a liability temperature for a liability system by providing an accurate liability risk measure based on a time-dependent, composite index parameter, wherein measurement parameters assigned to parameterized liability risk drivers are measured and transmitted to a central processing device of the electronic system for generating the measured time-dependent, composite index parameter, the method comprising:
scanning the liability system for the measurement parameters capturing dynamic and/or static characteristics of at least one liability risk driver, and automatically identifying and marking impacting liability risk drivers, the identified and marked liability risk driver either contracting or expanding the measured liability risk exposure;
selecting a first set of liability risk drivers by parametrizing an economic-based contribution to a general liability exposure loss, wherein the first set of liability risk drivers at least comprises a risk driver parametrizing Gross Domestic Product (GDP) growth, a risk driver parametrizing healthcare expenditure growth, and a risk driver parametrizing real wage growth based on an impact of captured alterations to the variable composite index parameter, the liability risk drivers being mutually normalized to each other;
selecting additional liability risk drivers by parametrizing at least societal and/or legal and/or political based contributions to the general liability exposure loss, dynamically applying additional liability risk drivers based on their impact to the measured variable composite index parameter and dynamically normalizing the liability risk drivers to each other, wherein for the normalizing of the selected liability risk drivers, applying a defined transformation to the final time series of the parameters by providing individual set weights and/or individual driver weights;
based on the weighted liability risk drivers and sets of liability risk drivers, selecting a minimum number of liability risk drivers in relation to maximized statistical significance, and providing the minimum number of liability risk drivers as a reduced set of liability risk drivers out of all available liability risk drivers using best fit characteristics; and
dynamically adapting the minimum number of liability risk drivers varying the liability risk drivers in relation to the measured liability exposure signal by periodic time response, and generating the time-dependent composite index parameter based on the adapted reduced set of liability risk drivers, the liability risk-driven interaction between a risk-transfer system and an operating device being adjusted based upon the time-dependent composite index parameter.

23. The method according to claim 22, wherein impacts of the liability risk drivers are scaled to a same scale applying, as normalization, the transformation to a final time series x_{†}=[x_{†}-min_{t′}(x_{t′})]/[max_{t′}(x_{t′})−min_{t′}(x_{t′})].

24. The method according to claim 22, wherein to select the minimum number of liability risk drivers in relation to maximized statistical significance based on the weighted liability risk drivers and sets of liability risk drivers, applying R²-maximization compared to a number of selected liability risk drivers.

25. The method according to claim 22, wherein to select the minimum number of liability risk drivers in relation to maximized statistical significance based on the weighted liability risk drivers and sets of liability risk drivers, applying Akaike Information Criterion (AIC)-maximization compared to a number of selected liability risk drivers.
